(19) United States
(12) Patent Application Publication
(10) Pub. No.: US 2009/0242450 A1
(43) Pub. Date: Oct. 1, 2009

(54) Air Packaging Device Product and Method for Forming the Product

(76) Inventors: Jiaying Zhang, Shanghai (CN); Yaopeng Zhang, Shanghai (CN)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/350,277

(22) Filed: Jan. 8, 2009

(30) Foreign Application Priority Data
Mar. 31, 2008 (CN) 200810035381.1

(51) Int. Cl. B65D 81/03; B32B 7/00

(52) U.S. Cl. 206/522; 428/178; 229/87.02

(57) ABSTRACT

An air packaging device comprises two layers of thermoplastic films, which form a sealable space where air is fulfilled after a 1^{st} and a 2^{nd} steps of heat-sealing process, includes a number of independent sealed air chambers and a main air passage channel. The main channel has an air inlet. Each sealed air chamber is connected with the main channel by at least one of one-way valves each consists of at least two layers of plastic films. At least two of one-way valves are installed inside of the air chambers. This air packaging device increases the cushioning protection where the protection is most needed, but can reduce air chamber dimension at the less important location in order to reduce the volumetric size and hence reduce the shipping cost.

### BACKGROUND OF THE INVENTION

1. Field of the Invention

This innovation provides a technical method to create a three-dimensional air sealable packaging material by combine using self-adhesive non-reversible air blockage technique (one way valve) and multi-layered functional polyethylene soft plastic resins. This material can be used in areas such as consumer electronics, glassware, high precision instruments and meters, art crafts, printer cartridges and products that are fragile, high consumer values and those requires high safety protection performances. This innovation integrates multiple functions such as direct load resistance, anti-vibration, being sealable and anti-humidity, good shock resistance that provides good protective performance and yet is considered as environmental friendly packaging material. It can be used in product protection, space void filling, product area protection or use as protective isolator cushions that are needed during shipping. Most importantly, it can also be designed as printable and hence can be directly used as sales packaging combining with protective performance.

2. Description of the Related Art

Globalization has increased the distance between the product manufacturing and product consumer market, and this trend has pushed the fast development of protective packaging in order to meet the long distance protection shipping needs. The traditional Expanded Polystyrene (EPS) and EPE products only be shipped to users after foam molding or processing at the supplier's factory location. The formed finish EPS products are large in size, and very inconvenient for transportation and storage. The on-site foaming materials developed for the convenience of transportation mainly use polyurethane foaming plastic materials to expand around the content article and form the protective mould around it. However, it is expensive to use and requires on-site equipment to process. That it also needs skilled workers as well as the working load makes it impossible for application for large scale product lines such as those for electronic products. Most importantly, the drawbacks of the Expandable Polystyrene products have caused many environmental concerns and it is becoming the “white pollution” of this century. Considering the fact that protective products made of EPS material are used in very short time span between manufacturing, shipping, warehousing for the commercial sales and finally to the consumer, EPS products are non-recyclable after use and it is non-degradable that lasts for hundreds of years once it is formed. The large volume of EPS packaging wastes has caused tremendous environmental damages since the incineration causes toxic gas to the atmosphere and sending to waste land fill will shorten the usage design of the waste land fill because these EPS products can not be decomposed for hundreds of years. With increasing concerns about the environmental pollution issues, the development of this foam plastic material is greatly restricted by the governmental regulation and public attentions. At the same time, products available to the protective packaging market are all limited by the large space volume needed to ship and to warehousing these packaging material. Shipping costs and warehouse handling costs have limited the sales of these products within short sales diameter distance. Hence, this innovation has focused on creating a marketable product that is easy for long distance transportation, on-site rapid formation, good protective performance, and yet is great beneficial to the environmental.

With the rapid development of soft plastic material, more and more industries can be benefited from the design and functional expendability by utilizing the properties of this material. The traditional air filling packaging generally uses the heat sealing technique to form simple round shape air bubble (BUBBLE WRAP), blocks or columns. The bubble wrap can be transported in rolls; however, products in other shapes request the installation of complex heat-sealing equipment on site to produce the product. As the protective effects and the transforming shapes of such products are limited, they are often used as padding or for filling space only. At the same time, air cannot be kept inside for long time due to unstable heat sealing quality when produced on site. Therefore, the development of packaging products using air as cushioning media has long been limited.

Literatures such as Walker (1981, U.S. Pat. No. 4,191,211) and Koyanagi (1987, U.S. Pat. No. 4,708,167) have recorded the use of valve structures made of soft plastic material such as rubber or latex. This valve material can be used in designs such as water bag, coffee bean bags and balloon toys. By using this soft plastic valve can provide a passage for air or liquid to enter but prevent the leakage of air and liquid. On the basis of such theory, using different materials may be applicable in different areas such as life-saving jacket and sealed devices to keep liquids such as the bladder. In 2005, Fu Jinfang in “Packaging Engineering” and Liu Gong in “Packaging and Food Machinery” published articles on feasibility study of using air for cushioning, providing the present invention a very good theoretical basis.

China's Patent Application No. 200510025833.4 published in Nov. 22, 2006 demonstrated an air packaging material and its production method by using self-adhesive non reversible air blockage technique. The invention related to an air packaging material and its production method which uses self-adhesive non reversible air blockage technique. Such packaging material, comprising 4 layers of plastic films, formed a space for air storage by heat-sealing at specified locations. The air can be preserved in the space in a long-lasting manner utilizing both the self-adhesive film and the function of air pressure. Air and soft plastic film form a functional material that could be designed to have different functions such as shock-resistance, compression-resistance and moisture blockage.

China's Patent Application No. 200580016507.5 published in Nov. 21, 2007 demonstrated an air packaging device structure with improved shock absorption property. The said device has the air packaging device with improved shock absorption performance for the protection of products inside the container case. The said air packaging device was comprised of: the first and second plastic films, which are adhered by heating at prefabricated locations to produce a number of air chambers; each air container has a number of serially connected air chambers; a number of one-way valves established at the entrances of the corresponding air containers allowing pressurized air to move forward; the air inlet publicly connected with the said one-way valves; the heat-sealing protrusions formed at the lateral edges of the air packaging device. The prefabricated points of the said air container are adhered to the heat-sealing edges. And thus, it created the open-mouth container part, which will wrap the product inside and the padding part in support of the said container part when the air packaging device is filled with pressurized air.

The air packaging device published by the above patent application is as illustrated in FIG. 1: the air, through the main channel 1 and the one-way valve 2, gets into air chambers 3. The air chambers 2 are roughly the same in diameter, and the maximum load bearing is uniformly distributed through out the surface area. When the packaged object falls, it equals that all the air chambers are impacted simultaneously same as a flat surface. In this case, the pressure that can be withstood is relatively small, and the cushioning effects are not very satisfactory.

On the other hand, after filling the air, the size of the object that can be contained in the internal space is basically defined. If the article is too big in size, it cannot be placed inside the air packaging device. On the contrary, if the article is too small in size, the article may create motion, shock and piercing of the air packaging device to fail the cushioning protection. In case of articles for packaging with slight differences in size (such as the 14 inch and 15 inch laptop computers), two sets of production techniques and moulds are required, leading to greater production costs. Meanwhile, increasing packaging volume will increase transportation costs, and will greatly increase the costs for end products in case of globalized purchase, manufacturing, transportation and sales. The present invention is therefore intended to obviate or at least alleviate the problems encountered in prior art.

### SUMMARY OF THE INVENTION

To solve the above problem, the present invention provides an air packaging device with greatly enhanced cushioning effects applicable in packaging of articles of various sizes. The packaging device can reduce the volume of the packaged articles, and thus greatly cut down transportation costs.

To achieve the above objectives, the present invention takes the technology program as follows:

An air packaging device, comprising two layers of thermoplastic films after two steps of heat sealing the plastic film to form a space to store the air, which includes a number of independent sealed air chambers and one main channel. The main channel has an air inlet. Each sealed air chamber is connected with the main channel by a one-way valve made of at least two layers of films. It is featured that parts of/all of the air chambers are installed with two and/or more one-way valves.

Load carrying capacity increases as the diameter of the air chamber increases, which means better protective effects, therefore, increasing the air chamber diameter in limited space can improve the load carrying capacity of the air packaging device. However, the increased air chamber diameter takes long time to fill the air, which may affect the packaging working time needed. Therefore, installation of at least two one-way valves in an air chamber of relatively bigger diameter will solve the problem of the air filling time.

wherein, the said sealed air chamber have different main diameters.

Due to the different main diameters of the air chambers, after being filled with air, the air chambers in bigger main diameter and the air chambers in smaller main diameter on the same surface will take wave-like shapes just like the corrugated paper structure of the packaging cartoons to greatly improve the carrying capacity of the packaging device.

As bigger air chamber diameter makes the bigger carrying capacity, which means better protective effects, therefore, increasing the air chamber diameter in limited space can improve the load carrying capacity of the air packaging device to achieve better protective effects. However, due to the limited space, the main diameters of air chambers in some major areas are increased to improve the load carrying capacity therein while reducing correspondingly the main diameters of the air chambers in less important areas. Another main purpose to increase the air chamber diameter only in most important areas is to reduce the packaging volume. Increasing cushion in major areas and reduce the air chamber diameters in areas requiring less protection can effectively reduce the volume to cut down transport costs correspondingly. The volume will be large if all the air chambers are same in size.

Wherein, preferably, the big and small air chambers of the said packaging device are alternatively distributed. Such structure, after being filled with air, the big and small air chambers will take on wave-like forms with only the air chambers of bigger diameter in touch with the article being wrapped. Like the corrugated paper packaging, its own load carrying capacity is bigger than that of the surface in touch with the basic plane formed by the same air chamber.

Wherein, preferably, the said packaging device is a rectangle bag with opening at one end.

In this way, two packaging devices are required to wrap both sides of the article. Then, the packaging device is applicable only if one side of the rectangle article is suitable in measurements, making the range of application relatively wide.

Wherein, preferably, the said packaging device is bag-shaped.

The bag-shaped packaging device is suitable for articles of relatively higher packaging requirements to provide good all-around protection for the articles.

wherein, preferably, the main diameters of the air chambers at both sides of the packaging device are relatively small while the main diameter of the air chamber at the middle is relatively big.

wherein, preferably, the one-way valves sealed by heat plastic packaging may be used in one or more air chambers of relatively small main diameter to block the air incoming channel therein.

In this way, on the basis of the original products, adding a working procedure of plastic heat sealing of the small air chambers around the lateral pressurized air chamber will get a packaging device for articles in other measurements without the need for new mould, greatly cutting down the production costs. In addition, the working procedures may be adjusted from time to time according to demands, satisfying the actual needs and cutting down inventories.

A packaging device production method, comprising the 1^{st} step plastic heat sealing and the 2^{nd} step plastic heat sealing, is featured that the 1^{st} step plastic heat sealing includes the following steps:

1^{st} heat sealing process to produce semi-finished packaging products having air chambers with a number of one-way valves installed and this semi-finished products are then stored in rolls for future use

Having the above semi-finished products undergone a 2^{nd} time heat sealing process by going through one-step plastic heat sealing machine, further dividing some air chambers with multiple one-way valves into independent, small-diameter air chambers or connected space as required.

Using the production method of the present invention, the one-step plastic packaging machinery may be employed in preparation to process 1^{st} step semi-finished products with a number of one-way valves of big air chamber diameter of various universally standards. When receiving orders, directly process partition lines on the prepared semi-finished products to divide the big air chambers into independent small air chambers. With preparation in spare time, the efficiency of one-step plastic packaging production will be greatly improved when having orders, resulting in greatly improved production of finished products. This will also make it convenient for factories in making production arrangements.

Using on-site direct forming method can greatly reduce the package volume and hence the transportation costs, solving the problem of excessively high costs of long distance transportation of packaging materials. The products are made completely flat prior to use by using the flexible plastic materials and prefabricated design. When using the products, such materials will be formed rapidly by air and form the protective structure around the article to be protected. Comparing with the existing technologies, the air three-dimensional packaging material of the present invention have excellent comprehensive protection functions such as anti-resistance, anti-vibration, anti-compression and cushioning. It can be used for padding packaging of articles, the partition board for local or major areas of articles, the overall external packaging for articles.

The present invention will become clearer in light of the following detailed description of illustrative embodiment of this invention described in connection with the drawings.

### BRIEF DESCRIPTION OF THE DRAWINGS

The present invention will be described via detailed illustration of the preferred embodiment referring to the drawings.

FIG. 1 is a perspective view of a conventional air packaging device.

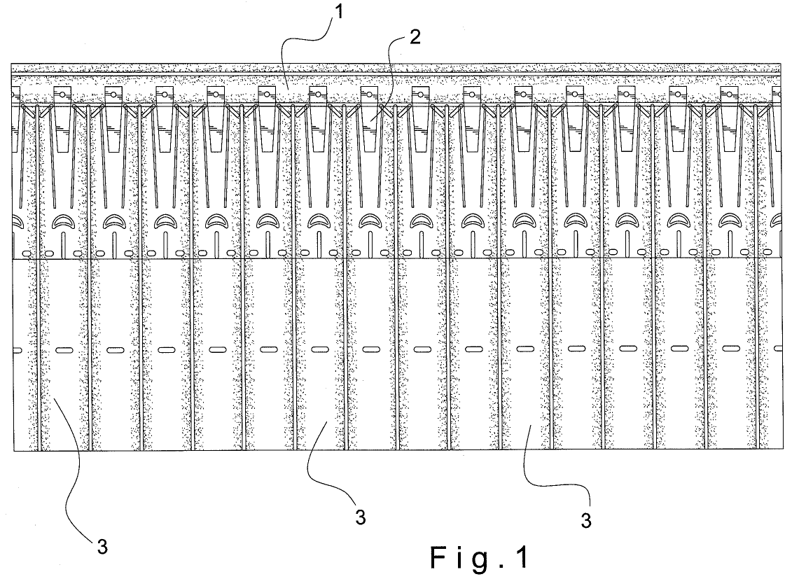

FIG. 2 is a cross-section view of the conventional air packaging device and an article contained with the air packaging device in FIG. 1.

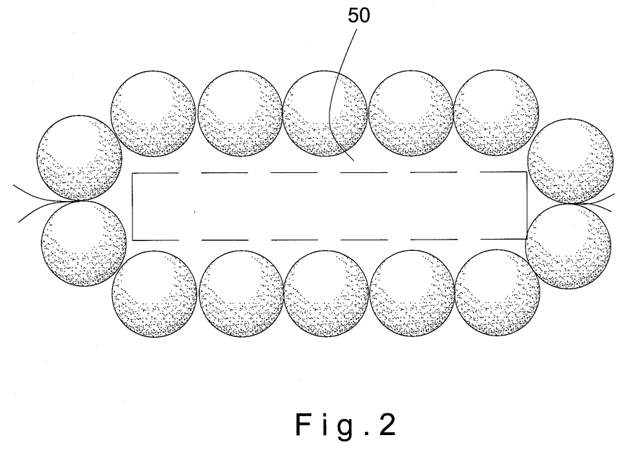

FIG. 3 is a perspective view of an air packaging device in accordance with the first embodiment of the present invention, prior to the 2^{nd} step heat-sealing process.

FIG. 4 is a perspective view of an air packaging device in accordance with the second embodiment of the present invention, prior to the 2^{nd} step heat-sealing process.

FIG. 5 is a perspective view of an air packaging device in accordance with the third embodiment of the present invention, prior to the 2^{nd} step heat-sealing process.

FIG. 6 is a perspective view of an air packaging device in accordance with the fourth embodiment of the present invention, prior to the 2^{nd} step heat-sealing process.

FIG. 7 is another perspective view of the air packaging device in FIG. 6, after folding and the 2^{nd} step heat-sealing process, and with illustrating a plurality of heat-sealing lines on the air packaging device.

FIG. 8 is a cross-section view of the air packaging device and an article contained with the air packaging device in FIG. 5.

FIG. 9 is a cross-section view of the air packaging device and an article contained with the air packaging device in FIG. 3.

FIG. 10a is a perspective view of the air packaging device (left) filled with air in FIG. 7.

FIG. 10b is a perspective view of the air packaging device (right) filled with air in FIG. 7.

FIG. 11 is another perspective view of an air packaging device similar to FIGS. 10a and 10b.

FIG. 12 is another perspective view of an air packaging device similar to FIG. 11.

### DETAILED DESCRIPTION OF THE PREFERRED EMBODIMENT

The air packaging device of the present invention will be more readily understood upon a further deliberation of the following detailed descriptions of a preferred embodiment of the present invention with reference to the accompanying drawings.

The 1st step heat sealing refers to form a plane bag for air storage by post heat sealing treatment of two layers of thermoplastic films and one-way valve. The 2nd time heat sealing process refers to the heat sealing process of forming the three-dimensional bag for storage along the heat sealing line after the 2nd time heat sealing process based on semi-finished products manufactured from the 1st step heat sealing process.

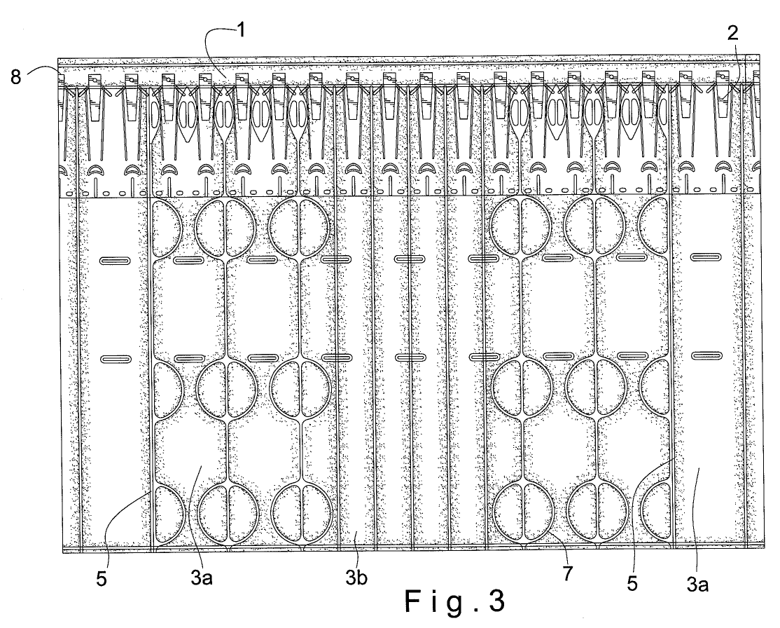

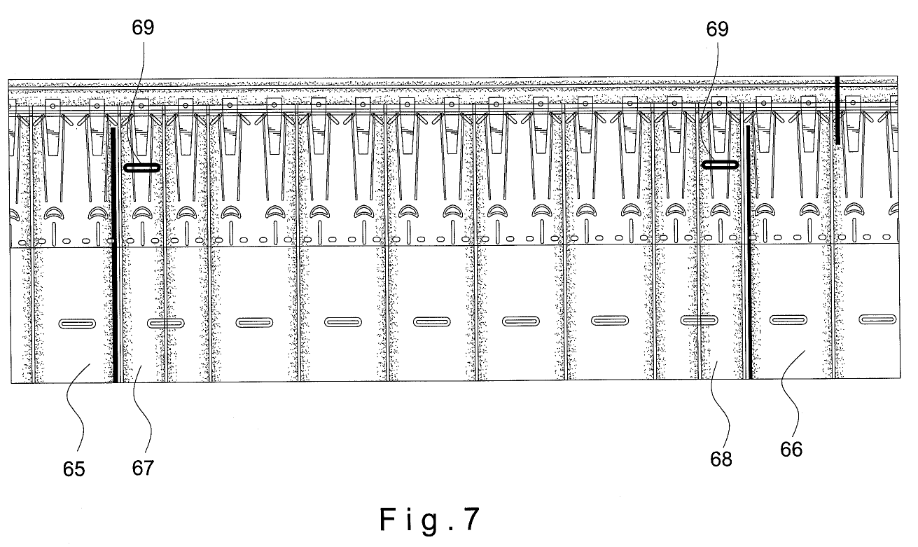

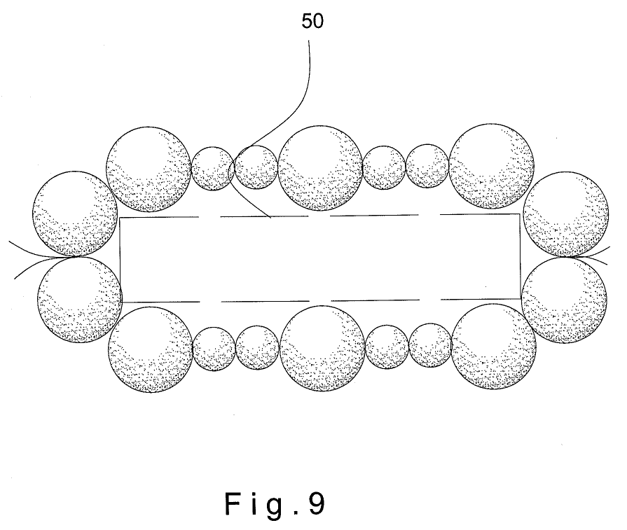

FIG. 3 depicts the embodiment of the said air packaging device of the present invention before going through the 2nd step heat sealing process. It differs from the existing technology in: first, the main diameters of the air chambers at both sides as shown 3a, are the same, and are bigger than the diameter of the air chamber in the middle as shown 3b; Second, side air chamber 3a connected with main passage tunnel 1 with two one-way valve, but middle air chamber 3b only installed with one air valve 2; thirdly, the heat sealing line created by 2nd step heat sealing (line, 5), is the sealing line between the first and second air chamber at both sides, making the first air chamber at both sides the side pressure chamber for lateral cushioning. Close the end of the main channel of the semi-finished product depicted in FIG. 3, wrap upward, similarly to FIG. 7, heat sealing the upper and lower parts of FIG. 3 along the heat sealing line during 2nd step heat sealing process 5, to form a bag with upper opening. When using on site, fill the air into each air chamber through the inlet 8 of the main channel 1, then wrap the article at both ends by two such packaging devices for packaging. Installing two one-way valves in one air chamber makes it easy to increase the air chamber diameter, and thus correspondingly increase the carrying capacity of the air chamber. The diameters of air chambers at both sides are bigger than the diameter of the air chamber in the middle in structure similar to the internal structure of alternatively distributed small and big air chambers as depicted in FIG. 9. The contact surface in between the air chamber and the article will take a wave-like form in structure similar to the corrugated paper. This will greatly increase the carrying capacity of the packaging device in accordance with physics theory. Meanwhile, the design of the heat sealing line 5 during 2nd step heat sealing process on the sealing line of the first air chambers at both sides (i.e. the left and right side pressure chambers) and the second air chamber will protect the article in all aspects as the side pressure air chambers have the lateral cushioning effects.

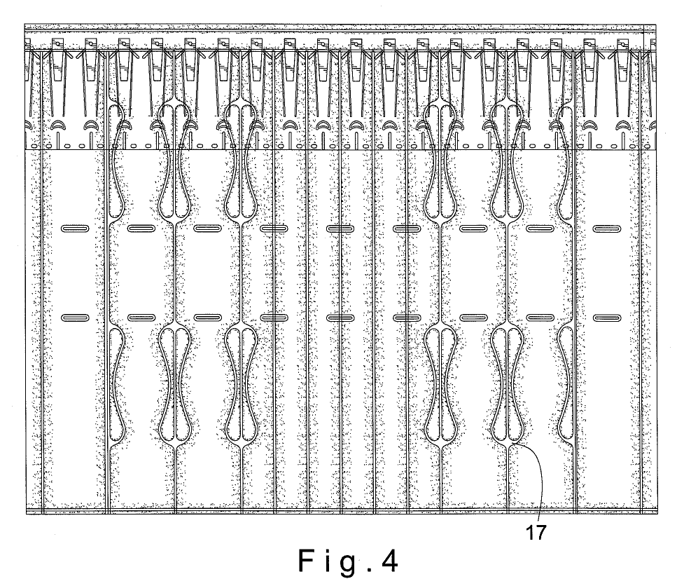

FIG. 4 depicts the second embodiment of the air packaging device of the present invention before going through 2nd step heat sealing process. It differs from the first embodiment in using purposely designed heat sealing lines of different shapes. FIG. 3 adopts the round shape heat sealing line 7 while FIG. 4 adopts “8” shaped heat sealing line 17. The heat sealing line will form one or more closed spaces. The air cannot penetrate into the enclosed air chamber but inflated air chamber around these closed spaces. The sealed space is protected by the surrounding air chambers and free from the external impact, being applicable to articles with parts of relatively higher requirements regarding impact.

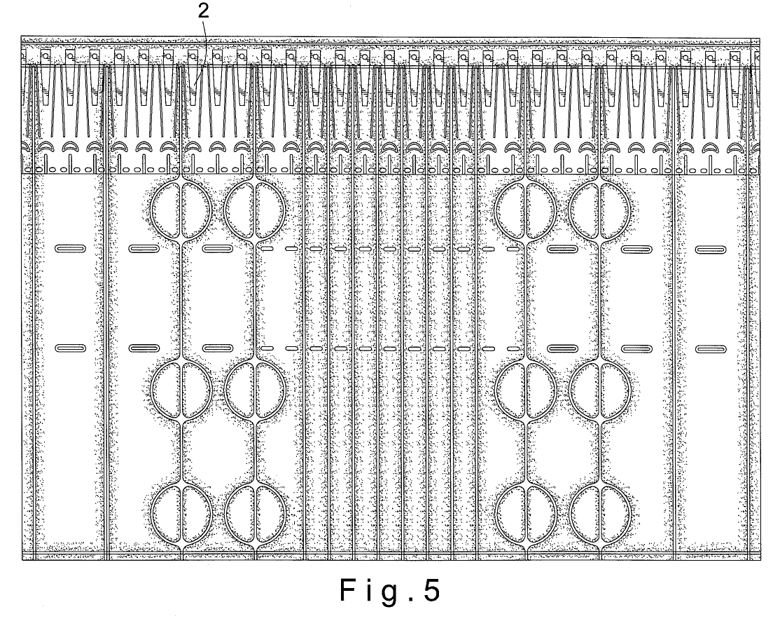

FIG. 5 depicts the third embodiment of the air packaging device of the present invention before the processing 2nd step heat sealing process. It differs from the first embodiment in: the diameters of the air chambers at both sides are bigger with three one-way valves 3. The increased main diameters of the air chambers at both sides will improve the maximum carrying capacity of the air chambers.

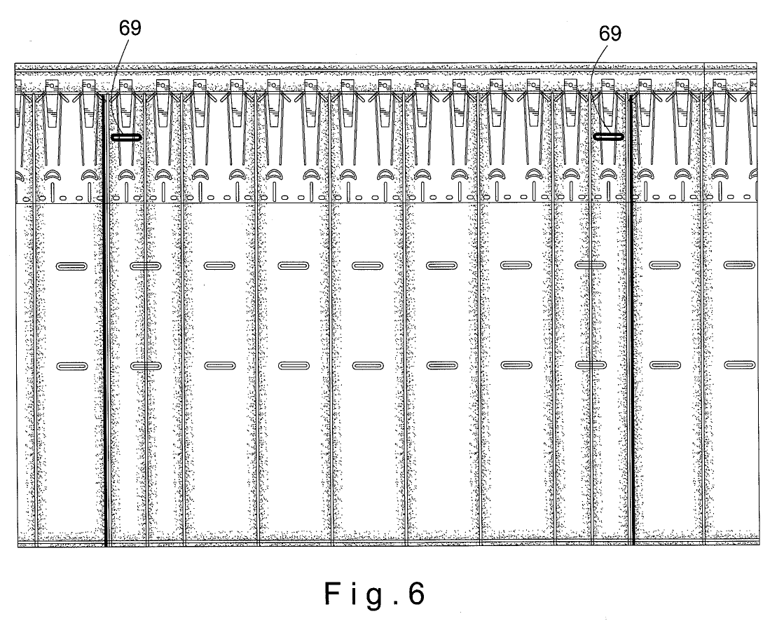

FIG. 6 and FIG. 7 depict the fourth embodiment of the air packaging device. FIG. 6 depicts the one before processing 2nd step of heat sealing procedure and FIG. 7 depicts the one after the 2nd step of heat sealing procedure. They differ from the previous three embodiments in: two small main diameter air chambers 67, 68 are next to the first air chambers at both sides, namely, the left pressure air chamber 65 and the right pressure air chamber 66. Between the air chamber 67 and 68, there are a number of air chambers of same diameter as the left and right side pressure air chambers 65 and 66. There is a heat sealing line 69 on the one-way valves of the small diameter air chambers 67 and 68 next to the left and right side pressure air chambers 65 and 66, sealing off the one-way valves of the air chambers to make it unable to fill the air. After air inflation, its horizontal length is slightly larger than the length when all the air chambers are filled with air for packaging devices with variations in length such as the 14 inch and 15 inch laptop computers. As big diameter air chambers are in both sides of the small diameter air chambers, it bears on pressure of impact. The cushioning protection of the packaging device will not be affected if the small diameter air chambers are not filled with air. In this way, adding a working procedure of plastic packaging of sealing off the one-way valve of the small air chambers can produce packaging devices of two specifications. As no new moldings are needed, the production costs will be cut down greatly and the products on the production line can be modified at any time in line with production without excessively more inventories.

The number of small diameter air chambers can vary according to the actual design. The sealed air chamber can be one or more according to the actual situation.

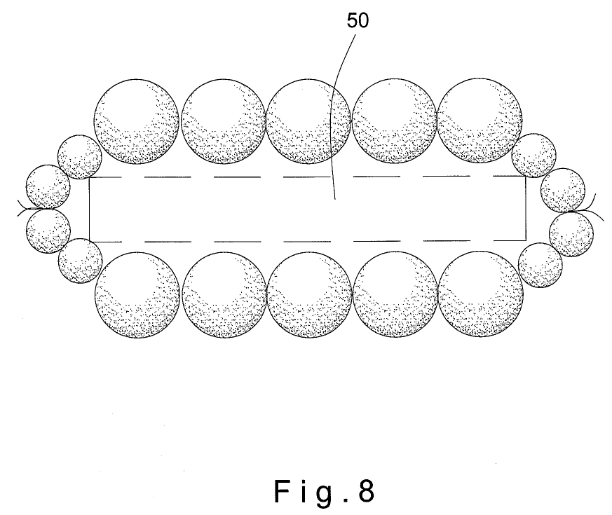

More importantly, as depicted in FIG. 8 and FIG. 9, in case of packaging devices in same measurements, the one with small-diameter air chambers around the heat sealing line after 2nd step heat sealing process can contain an article 50 of bigger volumetric size than the one contained in the packaging device with equal size diameter air chambers. Adding cushioning in major parts and cut down the air column size in area without need of protection can effectively reduce volume and transportation costs. Although the volume reduction of single packaging is limited, the saved transportation costs will be considerable in case of long batch of products for long distance transportation.

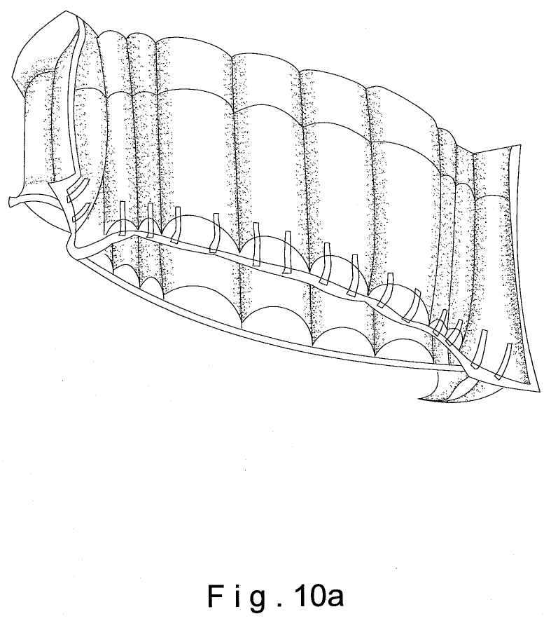

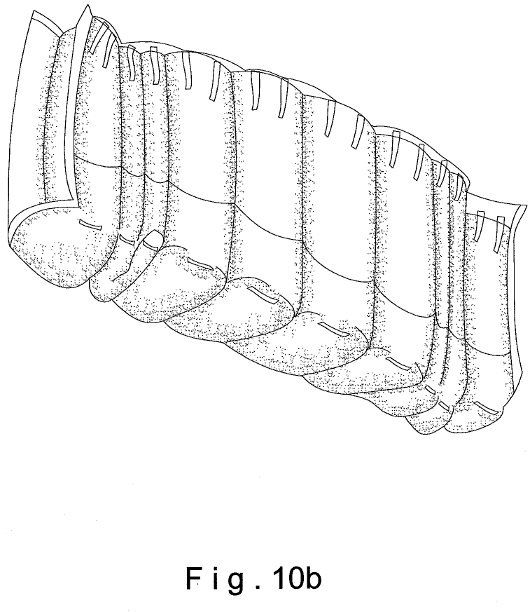

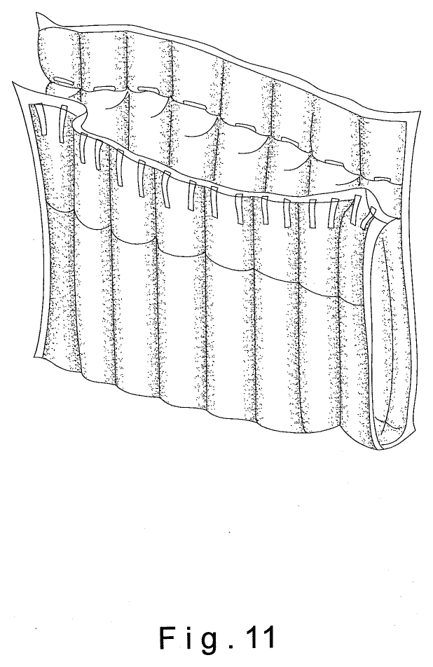

FIGS. 10a and 10b depicts the air packaging device with unsealed small diameter air chambers as depicted in FIG. 7 after being filled with air. FIG. 11 depicts the air packaging device similar to the one depicted in FIGS. 10a and 10b.

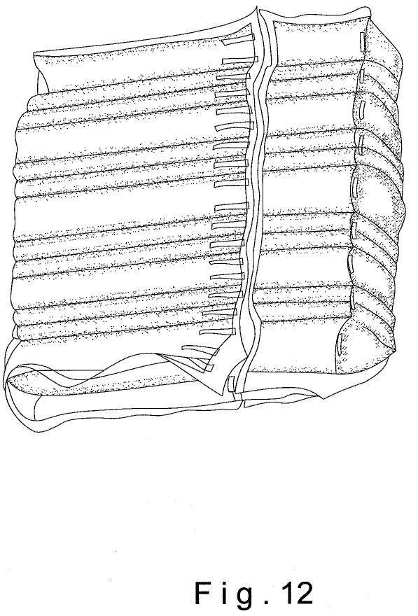

All of the embodiments of the air packaging device as aforementioned can be made into a wrapping bag with open end as depicted in the above embodiments. As illustrated in FIGS. 10a, 10b and 11, the concurrent use of two same packaging devices can realize the cushioning protective function. Or overlap the upper and lower parts of the semi-finished material after the 1st step heat sealing process and then going through the 2nd step heat sealing process to form the bag as depicted in FIG. 12. In this way, only one packaging device is needed to have the cushioning protection.

The production method of the present invention of air packaging device employs 1st step and 2nd step heat sealing processes, comprising the following steps:

By using 1st heat sealing process to produce the semi-finished materials having air chambers with a number of one-way valves and these material can be easily re-wind in rolls for future use;

Have the above semi-finished products undergone heat sealing process again in one-step plastic packaging machine, further dividing some air chambers with multiple one-way valves into independent, small-diameter air chambers or connected space as required.

Finally, use the 2nd step heat sealing process machinery to form the finished products.

As the air packaging devices are usually produced according to customers' orders without large number of inventories, the production time will be very short after receiving orders. At the same time, the production of the heat sealing process is relatively slow. The production time will be long if the materials are processed by the first heat sealing and the second heat sealing process in sequence, making it hard for workers who may have to work extra hours for production deadlines. By the production method of the present invention, semi-finished products may be prepared for universally standard big diameter air chambers with a number of one-way valves. When receiving orders, partition lines may be directly processed on the basis of the prefabricated semi-finished products, dividing the big air chamber into independent small air chambers or adding local heat plastic sealing transformations for local protection. Thus, preparations can be made in free time in between orders, and the production efficiency can be greatly improved when the production volume increases suddenly to greatly speed up the production of finished products. This will also make the production arrangement easy for the factory.

Applying the design of the above invention can produce functional packaging materials in various forms with lightproof, waterproof, moisture-proof, anti-wear, anti-compression, and shockproof properties including sealed bag and U-shaped bag. Meanwhile, features of plastic films can provide other features including anti-static, conductive, shock-cushioning, anti-wearing, anti-rusting and printable functions. Being different from the traditional air leakage-proof devices, the design of the present invention needs no external mechanical air stop device. Instead, relying on the specially treated internal and external functional films, by a series of simple local heat sealing processes, the air can be kept in an enclosed space. According to this principle, a series of products and derivative products in relation to functional self-adhesive non reversible air blockage technology to form three dimensional packaging materials can be produced. Any change of product shape and function by changing the heat sealing shape, wrapping pattern, the heat sealing specifications and positions or by different cutting or selection of different plastic film features belongs to the scope of the present invention, subject to the purpose of the present invention.

Deliberative but not limiting descriptions of the embodiment of the present invention have been made. However, it should be understood that the technical staffs in this field may make changes and/or modifications without being away from the related scope of protection as defined in Claims.

What is claimed is:

1. An air packaging device, which forms a space for air storage by comprising:
two layers of thermoplastic films together using 2 steps of heat sealing processes, includes a number of independent sealed air chambers and a main channel, with the main channel having an air inlet, with each sealed air chamber connected with the main channel by a one-way valve composed of at least two layers of films;
wherein the feature of the invention is that some air chambers or all of the air chambers are installed with at least two one-way valves.

2. The air packaging device defined in claim 1, wherein the main independently sealed air chambers referred to are different in diameters.

3. The air packaging device defined in claim 2, wherein the small and big air chambers of the independently sealed air chambers referred to are alternatively distributed.

4. The air packaging device defined in claim 2, wherein the air chambers at both sides of the independently sealed air chambers are smaller while the air chambers in the middle are relatively bigger in diameter.

5. The air packaging device defined in claim 4, wherein that the one-way valves of air chambers at both sides can be closed by post heat sealing the air inlet passage.

6. The air packaging device defined in claim 1, wherein that the packaging device referred to is a rectangle bag with one end open.

7. The air packaging device defined in claim 2, wherein that the packaging device referred to is a rectangle bag with one end open.

8. The air packaging device defined in claim 5, wherein that the packaging device referred to is a rectangle bag with one end open.

9. The air packaging device defined in claim 1, wherein the packaging device referred to is in the shape of a bag.

10. The air packaging device defined in claim 2, wherein the packaging device referred to is in the shape of a bag.

11. The air packaging device defined in claim 5, wherein the packaging device referred to is in the shape of a bag.

12. The air packaging device defined in claim 1, wherein the packaging device referred to is installed with side pressure air chambers.

13. The air packaging device defined in claim 2, wherein the packaging device referred to is installed with side pressure air chambers.

14. The air packaging device defined in claim 5, wherein the packaging device referred to is installed with side pressure air chambers.

15. The air packaging device defined in claim 6 is featured that the packaging device referred to is installed with side pressure air chambers.

16. The air packaging device defined in claim 7 is featured that the packaging device referred to is installed with side pressure air chambers.

17. The air packaging device defined in claim 8 is featured that the packaging device referred to is installed with side pressure air chambers.
